(19) United States
(12) Patent Application Publication
(10) Pub. No.: US 2017/0204920 A1
(43) Pub. Date: Jul. 20, 2017

(54) BI-LAYER IRON COATING OF LIGHTWEIGHT METALLIC SUBSTRATE

(71) Applicant: NATIONAL RESEARCH COUNCIL OF CANADA, Ottawa (CA)

(72) Inventors: Dominique POIRIER, Boucherville (CA); Eric IRISSOU, Longueuil (CA); Jean-Gabriel LEGOUX, Repentigny (CA); Danick GALLANT, Saguenay (CA)

(73) Assignee: NATIONAL RESEARCH COUNCIL OF CANADA, Ottawa, ON (CA)

(21) Appl. No.: 15/316,722

(22) PCT Filed: Jun. 4, 2015
(86) PCT No.: PCT/IB2015/054239

§ 371 Date: Dec. 6, 2016

Related U.S. Application Data
(60) Provisional application No. 62/008,826, filed on Jun. 6, 2014.

(51) Int. Cl. F16D 65/12; B32B 15/18; C23C 4/02; C23C 24/04; C23C 28/02; C23C 4/08; B32B 15/01; B32B 15/20

(52) U.S. Cl. CPC F16D 65/127; B32B 15/012; B32B 15/18; B32B 15/20; C23C 24/04; C23C 28/021; C23C 4/08; C23C 4/02; B32B 2307/554; B32B 2475/00; F16D 2200/0021; F16D 2200/003; F16D 2250/0046

(57) ABSTRACT

A wear resistant friction coating (WRFC) can be applied on a lightweight metallic substrate, by applying a cold gas dynamic spray bond coat containing more iron than any other single element directly onto a surface of the substrate, and thermal spraying the WRFC coating over the bond coat to a thickness of at least 500 μm. Corrosion resistance, adhesion, thermal cycling resistance, and wear resistance have been demonstrated.

### Field of the Invention

The present invention relates in general to iron bearing coatings on lightweight metallic substrates, and in particular to such coatings that are thick, and exhibit strong adhesion and wear resistance, especially on brake parts.

### BACKGROUND OF THE INVENTION

Most attempts to produce iron-based wear resistant friction coatings (WRFCs) on lightweight metallic substrates (e.g. Al, Al alloys, Mg, Mg alloys, and their metal matrix composites, and the like) have used arc spray deposition, although other thermal spray (air plasma, plasma, high velocity oxygen fuel, flame spray) systems have been used, and are certainly well known. While iron-based coatings typically produce good wear resistance, there seem to invariably be problems with adhesion of the coating, especially if the coatings are thick, and/or the coated system is subject to heat cycling. Unfortunately many cases where WRFCs are required, are on wear surfaces of moving parts, such as in friction braking surfaces and pads, where substantial heat is generated abruptly leading to thermal cycling, and where thick iron coatings are desirable for better heat shielding, to lower the temperatures to which the lightweight metallic substrate is exposed.

For many WRFCs, it is desirable for parts formed with lightweight metal, to be provided with thick iron-based coatings that shield the parts from excessive heat, provide adequate tribological surfaces for the frictional meeting of surfaces, for dissipation of heat homogeneously throughout the part, and resistance of wear and corrosion. While there is demand for brake parts in automobile and other applications, and a desire to lightweight brake parts using aluminum, or magnesium, instead of cast iron brakes, thus far coatings have not been able to withstand the environment of a brake.

For example Weiss 1981 “Friction and Adhesion Investigations of Metal Coatings on Aluminum Alloys” teaches applying arc-spraying of Fe with small amounts of Cr, C, Ni, Mn and Si onto Al rotors, to form three types of coatings classified by Brinell 30 hardness: 2500-2700; 3000-3400; and 3800-4400. While these coatings apparently exhibited good adherence, it is noted that: “An undercut dovetail at the edges has also proved to be useful and in some cases necessary for adhesion.”, and “Thinner (than 0.9 mm) sprayed coatings leave too small a machining allowance for grinding and less satisfactory adhesion conditions have been found with thicker (than 1.2 mm) coatings.” “Further development is necessary in this respect for the disc brakes because of the relatively thin wearing coating.” Forming undercut features adds time and expense to machining a part. Corrosion is expected to be a problem with these coatings and is expected to affect the arc-sprayed coating and its adhesion. This would prevent long term use of such technology in most operating environments. This disclosure attests to the fact that there has been a desire to produce friction breaking coatings on aluminum rotors for 30 years.

U.S. Pat. No. 6,290,032 ('032) to Patrick et al. teaches applying a wire-arc thermal spray coating consisting of Al and stainless steel onto an aluminum or aluminum alloy rotor. To avoid delamination, the patent teaches substantial surface roughening, or grooves. Debonding under corrosion or thermal cycling may remain a problem, if a high mass ratio of iron/steel is used, as may be desired. The cost of producing a substrate with surface roughening to the degree shown in FIG. 3B of '032 may have precluded commercial application of this invention, and the depth of groove required to provide adequate bonding for the embodiment of FIG. 3A may require machining for a long duration, increasing a time and cost of production. The mixed Al, stainless steel might also have unsatisfactory tribological properties, or longevity, and would expect to have poor corrosion resistance.

U.S. Pat. No. 5,407,035 ('035) to Cole et al., entitled “Composite Disk Brake Rotor and Method of Making” teaches applying one or more coatings on a roughened lightweight metal disk brake rotor by electric arc sprayed co-deposit of iron-based material and powdered graphite to form an iron matrix composite coating, followed by surface heat treating the exposed coating to dissolve and precipitate graphite, and form a simulated cast iron to densify the coating and remove residual stresses. FIG. 3 of '035 teaches that an intermediate coating or layer 23 may be used either to act as a thermal barrier or to augment chemical bonding between the outer coating 22 and the lightweight metal rotor and to compensate for thermal expansion mismatch between the rotor and the overlayer. At C3,L29-39, Cole et al. teaches various compositions for the intermediate coating (Ni/graphite, Al/cast iron, Ni/graphite Al, Ni based alloy), applied by electric arc spraying, plasma spray, or wire-fed arc spray.

Another reference that teaches arc spray deposition of iron-based coatings onto aluminum is a paper entitled Wear of Thermal Spray Deposited Low Carbon Coatings on Aluminum Alloys, to Edrisy et al. Wear 251 (2001) 1023-1033. This does not address coating debonding.

A machine translation of WO2013038788, specifically Japanese publication number 2013-064173, application number 2011-202682 to Terada Daisuke et al., has been reviewed, and while the machine translation appears to suggest another composition desired for improving “separation resistance” and “peeling resistance” of a thermal spray coating (electric spraying methods and plasma spray process are mentioned, as are powder, wire and rod feeds), it is reasonably clear that the “peeling resistance” referred to in this document is wear resistance or abrasion resistance. The adhesion does not appear to be explained in the application. It will be appreciated that cylinder bore surfaces (the application of concern), unlike many WRFCs, are not subject to high friction, corrosion and thermal shocks, and there is no suggestion that the coatings are thick.

It will be noted that all of the above references seem to prefer arc deposition and each concerns itself with mechanical interlocking, and/or composition of the coating, to produce the coating, or makes no mention of debonding or corrosion.

U.S. Pat. No. 6,949,300 to Gillispie et al. teaches kinetic gas sprayed coating of Al or Al alloy surfaces, their coatings are formed of 4 principal metal components, having possible trace amounts of other metals among which iron is listed. The coating is noted to provide corrosion protection for heat exchangers.

It is generally known in the field of cold gas dynamic spray, that such coatings generally have higher density, and lower porosity, that tend to provide better corrosion resistance than arc sprayed coatings. Cold gas dynamic sprayed coatings, in general, display good coating adhesion, and good corrosion resistance, (see Davis, J.R., Handbook of Thermal Spray Technology, 2004, ASM International, 347 p., and Irissou et al., Review on Cold Spray Process and Technology: Part 1-Intellectual Property, JTST 17(2), Dec. 2008, pp. 495-516). However, tribological properties of cold gas dynamic sprayed metal layers are not satisfactory for wear resistance and friction applications.

There remains a need for lightweight metallic parts to be reliably, and inexpensively coated with wear surfaces, to form rotor and stator parts of brakes, friction pads of clutches, and other tribological coatings, or for surfaces that are otherwise subjected to thermal shocks and thermal cycles, as may be used in heavy, medium or light machinery, and for subterranean, underwater, land and water surface, aerial and aerospace vehicle applications. In particular, lightweight parts are important for fast moving or rotating parts, or for braking surfaces that absorb substantial kinetic energy, where lightweighting is valuable.

### SUMMARY OF THE INVENTION

Applicant has discovered a solution to this longstanding problem that does not require expensive preparation of the lightweight metallic substrate surface, and provides improved adherence of thick iron coatings. Applicant has shown that bi-layer coatings composed of more iron than any other element, can be deposited on lightweight metallic substrates to form corrosion resistant, wear resistant friction coatings (WRFCs), have good wear properties (constant coefficient of friction, and longevity), and good adhesion, even under thermal cycling. The solution involves the use of a cold gas dynamic spray bond coat between a thermal sprayed WRFC and the surface of the part to be protected. Advantageously the bond coat may be composed of an iron-based material, whereby the bond coat further adds to the thermal shielding of the friction braking coat. Herein a bi-layer coating is to be understood as a coating having at least 2 distinct layers, a duplex coating is understood to have exactly two distinct layers, and a triplex coating is understood to have exactly three distinct layers, where layers are distinct by virtue of their morphology, density, or composition.

Accordingly, a method is provided for depositing a WRFC on a lightweight metallic substrate. The method comprises: exposing a surface of the lightweight metallic substrate (advantageously undercutting or extreme roughening is not required, and even standard roughening may be unnecessary); applying a cold gas dynamic spray bond coat (preferably containing more iron than any other single element) directly onto the surface; and thermal spraying the WRFC coating over the bond coat to a thickness of at least 300 μm above the substrate.

The thermal spraying may involve operating a thermal spray torch and a feedstock supply to feed coating material to a plume of the thermal spray torch, for at least partial melting, and acceleration of the material, toward the bond coat. The feedstock supply may be a wire feed. Operating the thermal spray torch may involve controlling an arc to form the plume. The feedstock supply may feed a coating material for depositing a coating consisting of more iron than any other element.

The thermal spraying may be deposited directly onto the bond coat, or the method may further comprise applying one or more intermediate layers on the bond coat prior to the thermal spraying. Each intermediate layer may be applied by thermal spray, or cold gas dynamic spray, so that only the cold gas dynamic spray and arc spray torches are needed for the deposition. For example every layer may be produced by spraying at least one cold gas dynamic spray layer (including the bond coat), followed by at least one thermal spray layer, with at least a final thermal spray layer defining the WRFC, or by alternating between cold gas dynamic spray and thermal spray. Applying one or more intermediate layers may comprise varying a thermal spray or cold gas dynamic spray parameter during the coating to produce an intermediate coat having a graded composition, microstructure, or density. Similarly, applying the bond coat may comprise varying a cold gas dynamic spray parameter during the spraying to produce a bond coat having a graded composition, microstructure, or density.

Applying the bond coat may comprise cold gas dynamic spraying a feedstock powder consisting of more iron than any other element. The feedstock powder may comprise 80 wt. % or more of a steel powder, and may contain only steel powder, or powdered steel and powdered additives of steel.

Exposing the surface on the substrate may comprise roughening the lightweight metallic substrate, by peening, blasting, grinding, or ablating, for example, but this is not necessary. Advantageously, the surface may be prepared by cleaning alone, which avoids substantial costs, and reduces defects that result from grit that typically becomes embedded in the surface during some of these roughening processes.

Also accordingly, a machine part is provided, the part having a structural member composed of a lightweight metal or composite with a wear surface for friction contact with a second part. The wear surface has the following structure: a dense metallic bond coat with a microstructure consistent with formation by cold gas dynamic spray that is bonded directly to the structural member; and a wear resistant friction coating (WRFC) provided over the bond coat, having a microstructure consistent with formation by thermal spray; where: the WRFC is bonded directly to the bond coat, or to an intermediate coat; the wear surface is composed of more iron than any other element by mass and has a thickness greater than 300 μm.

The lightweight metal or composite is formed with a substantial amount (such as more than 50 molar %, or more than 60 molar %, or more than 80 molar %) of lightweight metal, such as Al or Mg. The examples provided herein all concern Al and its alloys, however it will be apparent to those of skill in the art that Mg has very similar properties as Al when it comes to forming adherent coatings by cold gas dynamic spray, and it will be appreciated that very few, if any, coatings have been formed by cold gas dynamic spray on Al that cannot equally be formed on Mg (and vice-versa). The densities, corrosion resistances, bonding and thermal shock resistance of metals cold gas dynamic sprayed onto solids, do not typically vary depending on whether the substrate was Al or Mg (or depending on their alloys).

If Al, Al alloy, or a composite of Al or an alloy of Al, is used, it may further comprise one or more of the following: Si, Mg, Cu, Li, Zn, Fe, Ni, Cr, Mn, Ti. If a composite of Al is used, it may be a metal matrix composite featuring non-anatase titania, such as, a rutile titania powder that is stir cast with a trace amount of Ca, as per the teaching of Applicant's co-pending PCT/CA2014/000102. The metal matrix composite can feature SiC, alumina, tungsten carbide, boron carbide, boron nitride, for example, in the form of whiskers, fibres, threads, nanotubes, rods, plates, disks, spheres, or cubes, for example, and may have dimensions in the macro-, micro-, or nano-scale.

The WRFC is preferably composed of a type of steel, containing more iron than any other element, and may contain at least 80 wt. % or more of a first steel. The first steel may comprise or consist of Fe, C and one or more of the following: Ni, Cr, Mn, Al, Mo, N. The bond coat may be composed of a type of steel, containing more iron than any other element. The second steel may comprise or consist of Fe, C and one or more of the following: Ni, Cr, Mn, Al, Mo, N.

The WRFC may have a microstructure consistent with formation by a wire-arc thermal spray torch. As such the WRFC will have inter-lamellar voids, oxides and features showing the buildup of solidified droplets (“splats”) in thin layers, from unmelted or partially melted particles. The oxides present in the WRFC are formed naturally during the spraying in air and imbue the WRFC with the necessary hardness and wear resistance. The WRFC may be bonded directly to the bond coat, or there may be one or more intermediate coats. Each intermediate coat may have a microstructure consistent with application by a thermal spray torch, or by cold gas dynamic spray. The wear surface may be composed of one or more cold gas dynamic spray layers covered by one or more thermal spray layers.

The bond coat, or the intermediate coat, may be graded in that a composition, microstructure, or density varies as a function of distance from the part.

A copy of the claims below are inserted here by reference.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIGS. la,b,c are schematic illustrations of three embodiments of parts having a wear surface in accordance with the present invention, respectively showing a duplex, a triplex and a graded bond layer embodiment;

FIG. 2 is a schematic block diagram showing principal steps in a method of producing a part with a wear surface, in accordance with an embodiment of the invention;

FIG. 3 is a cross-section micrograph of a duplex (bond coat/WRFC) coating in accordance with an example of the present invention;

FIG. 4 is a bar chart showing initial bond strength and number of cycles before spallation of the duplex coating of FIG. 3 in comparison with a cold gas dynamic sprayed coating and an arc sprayed coating;

FIG. 5 is a bar chart showing wear rates of the duplex coating of FIG. 3 in comparison with a cold gas dynamic sprayed coating and an arc sprayed coating, as well as bulk stainless steel and grey cast iron;

FIG. 6a,b,c are photographs showing comparisons of the duplex coating of FIG. 3 with cold gas dynamic sprayed, and arc sprayed coatings after a corrosion (salt spray) test; and

FIG. 7 shows a duplex coating of FIG. 3 after testing on a scale dynamometer.

### DESCRIPTION OF PREFERRED EMBODIMENTS

Herein a method of producing a wear surface is provided by teaching how a wear resistant friction coating (WRFC) can be adhered to lightweight metallic substrates. Herein a lightweight metallic substrate refers to a substrate composed of a substantial amount of a light, structural metal, such as Al or Mg, and expressly more of the light, structural metal than all heavy metal in the metal phase of the substrate. The metal phase refers to the whole substrate less any composite reinforcement constituents. The substantial amount would be at least 25 molar %, and is typically more than 35 molar %, or more than 40 molar %, and, for some materials, may necessarily be more than 50 molar %, but includes all materials classified as Al alloys, or Mg alloys, and all metal matrix composites of any of those alloys. Typically the metal phase itself will be at least 65 wt. % of one or more light structural metals or alloys. Herein a metal alloy does not include less than 30 wt. % of the specified metal, and does not have a single metal species in higher concentration than the specified metal.

FIGS. 1 a), b) and c) are three schematic illustrations of bi-layer coatings in accordance with an embodiment of the present invention. FIG. 1a) schematically illustrates a duplex coating with a cold gas dynamic spray bond coat 10 and a thermal sprayed WRFC 12, on a lightweight metallic substrate 11. To be deployed as a wear surface, typically it is desirable for the WRCF 12 to have a coefficient of friction (CoF) between 0.1 and 0.7, more preferably between 0.3 and 0.5, and the CoF should be stable, not varying by more than 0.1 with temperature, and not varying with wear.

Typically, WRFCs must also resist corrosion, and may be exposed to thermal cycling. To resist the high surface temperature achieved during braking, at a reasonable cost, an iron-based coating is preferred, although the WRFC 12 need not be principally composed of iron, even if the duplex coating as a whole is composed of more iron than any other element by mass. That is, WRFCs composed of more expensive tungsten carbide (for example), can be used where commercially viable. Suitable corrosion resistance is favored by providing at least 40 wt. % iron (preferably in the unoxidized state), measured by atomic emission spectroscopy (preferably in the unoxidized state). Advantageously, various steels have excellent tribological properties for producing WRFCs, and are economical. Accordingly, steel based WRFCs are preferred and the coating may include, or consist only of steel, such as the following grades of steel: stainless steel 200, 300 or 400 series. The WRFC 12 has a microstructure consistent with thermal spray deposition, such as by spraying with a plasma torch, or a combustion flame, sprayed by a wire-based feedstock or a powder feedstock. As such the WRFC will have inter-lamellar voids, oxides and features showing the buildup of solidified droplets (“splats”) in thin layers, from unmelted or partially melted particles. Oxides present in steel-based WRFCs are formed naturally during the spraying if performed in air, and imbue hardness to the WRFC needed for wear resistance.

A thickness of the WRFC 12 is selected for the use of the wear surface. A wear rate during an expected usage regime is chosen to provide an expected service life for the wear surface. For some materials the coating may be 50 μm or less, but in general applying a uniform coat quickly would result in a thickness of at least 100 μm, and more often, thicker still (such as 150-1500 μm, or more preferably 200-900 μm)

The bond coat 10 is provided for adhering the WRFC 12 to the lightweight metallic substrate 11. The bond coat 10 has a microstructure consistent with cold (gas dynamic) spray deposition: it has a high density, with low micro-porosity from inter-lamellar features; and is composed of elongated splats originating from the deformation and deposition of solid/unmelted powder particles. The bond coat 10 preferably has a thickness that is sufficient to protect the substrate from oxidation and improves corrosion resistance. A thickness of 200 μm was found sufficient to accomplish this, and it is believed that a thickness less than this will not be sufficient for most steels.

The lightweight metallic substrate 11 may be formed of Al, Al alloy, Mg, Mg alloy, or a metal matrix composite with a metallic phase of Al or Al alloy, or Mg or Mg alloy. A metal matrix composite may include reinforcements in the form of another metal, cermet, or a ceramic (such as a metal oxide, nitride, boride, or carbide) at least in the vicinity of the wear coating. Naturally the substrate 11 may be on a part composed of other materials in other areas. Specifically the substrate 11 may be composed of an Al-titania MMC as described in Applicants previously identified co-pending application, which may be formed in a manner that provides a substantially metallic Al surface, even if the body contains more rutile titania than Al. Preferably the part has a strength and stiffness suitable for use in high temperature, or thermal cycling environments, at moderately high pressure.

Together the bond coat and WRFC preferably have a thickness of at least 300 μm, and more preferably 400 μm, 450 μm, 500 μm, or more. Typically the whole bi-layer coating would have a thickness of less than 5 mm, and more commonly less than 2.5 mm or 2 mm. A minimum thickness is preferred to thermally shield the substrate, and an excessive thickness is generally avoided to avoid long deposition times and cost.

The embodiment of FIG. 1b) further adds an intermediate layer 15 to the embodiment of FIG. 1a) to form a triplex coating. The intermediate layer 15 may conveniently be formed by cold gas dynamic spray, or thermal spray such that a same two torches may be used to deposit the triplex coating as was used for the duplex coating of FIG. 1a. Intermediate layer 15 may be applied by either of the torches, by variation of a feed source, or another spray parameter, as is well known in the art. The intermediate layer 15 may be particularly rich in iron, and serve predominantly as a thermal shielding layer, especially if the WRFC 12 is not predominantly iron. A variety of wear resistant surfaces known to be applied to iron castings to produce brake coatings may be readily applied if the intermediate layer 15 has sufficient thickness to present a thermally, and chemically, Similar surface to a prior art iron casting. Advantageously, even a relatively thick intermediate layer 15 results in the part having much lower weight, than a comparable cast iron part. The intermediate layer 15 may preferably be composed of metals and possibly their oxides, and is preferably deposited by thermal spray or alternatively by vacuum-based coating techniques.

While the foregoing assumed that different torches are required for the bond coat and WRFC, it will be appreciated that a convergence between thermal spray (particularly HVOF-type) torches and cold gas dynamic spray equipment is ongoing. High Velocity Air Fuel (HVAF) and “warm spray” variants of HVOF (with higher melting point powder feedstock) are bridging the gap between what were previously considered distinct spray processes. Accordingly HVOF, HVAF, and warm spray torches are all considered herein cold gas dynamic spray torches to the extent that they produce dense, oxide-free coatings like cold spray torches. Within the next 20 years, it is entirely plausible that a single torch could produce both an effective cold gas dynamic sprayed bond coat, or reasonable approximation thereto, and a thermal sprayed WRFC, especially if higher and lower melting point iron-based feedstocks are used. What would generally be required is a torch that is operable to impart sufficient velocity to a spray jet to produce the bond coat with the desired density, preferably with limited oxidation, and without melting the feedstock, and a thermal spray process that melted the feedstock to increase an oxidation of the as-sprayed steel coating.

FIG. 1c) differs from the embodiment of FIG. 1a) in that the bond coat 10 is schematically illustrated as a graded coating. As is well known in the art, it is possible to deposit graded coatings, to minimize thermal and mechanical property mismatch at interfaces between the layers. For example, if the bond coat 10 has more Al towards the substrate, and more Fe at higher distances from the substrate, the coating may have a more stable metallurgical bond with the substrate, and this may improve adhesion to the substrate. Techniques for grading may involve a gradual change in feedstock composition, or morphology, or may be achieved by varying a feed rate, or other spray parameter such as: plume temperature, powder supplied, and stand-off.

There are a wide variety of parts upon which wear surfaces may be desired or required: brakes of all sizes, shapes and types, clutches, pushers, and rolling bearer pads, for example. While the parts may be of tools for gripping, like vices or clamps, it may be especially valuable to meet demand for light tools subject to local thermal shocks (caused by interaction of the surface with another, or by an external heat source, for example). These can have a very wide variety of shapes, but most frequently plates, disks, and drums are used, and pads of various shapes can be applied on a wider range of parts, such as calipers.

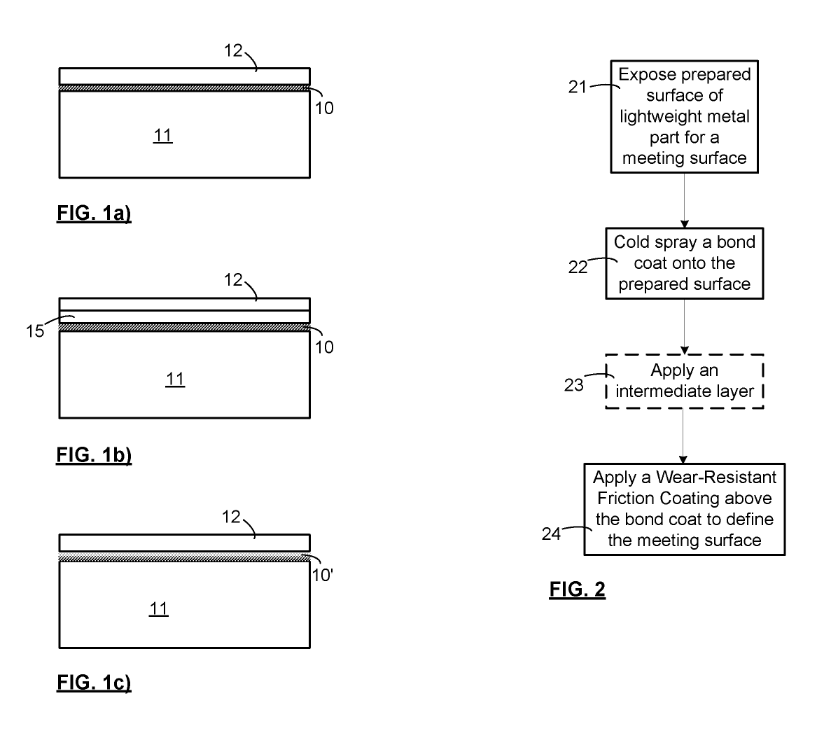

FIG. 2 is a schematic illustration of a method for producing a part with a wear surface, in accordance with an embodiment of the invention. The method involves exposing a prepared surface of the part to serve as the substrate 11 for a wear surface at step 21. Preparing the surface involves cleaning procedure to remove oil, dirt and dust using various methods well known in the art, such as solvent or industrial soap wiping or immersion, but advantageously does not involve surface roughening by etching, blasting, or peening, and extreme forms of surface preparation are not required. Sanding or brushing are low-cost, minor roughening techniques that may be preferred before, during or after cleaning to improve adhesion in some cases. At step 22 a cold gas dynamic spray bond coat 10 is applied to the surface. The bond coat 10 may contain more iron than any other single element, and is applied directly to the Al surface. It is within the purview of the ordinary skill in the art to select: feedstock for cold gas dynamic spray including steels, or combinations of steel, iron, or corrosion resistant materials; and appropriate high velocity thermal spray techniques such as cold gas dynamic spray, warm spray or HVOF and spray parameters. Optionally, the bond coat 10 may be graded, preferably with a high density at the interface with the lightweight metal, for good adhesion thereto, and for corrosion resistance, and a hard, and less smooth, surface for supporting a WRFC.

In step 23, the process optionally involves applying an intermediate coat. The intermediate coat may be composed of metals and their oxides, and is preferably deposited by thermal spray or a vacuum-based coating deposition technique, such as a vacuum deposition method.

Finally, in step 24, a WRFC 12 is applied, to provide the wear surface with a desired friction surface. Other types of material particles, such as carbides (WC, CrC, SiC) or oxides (SiO₂, Al₂O₃, TiO₂) may be used, or admixed with a steel powder to improve wear resistance, deposition efficiency, or adhesion properties while maintaining reasonable cost.

The bond coat can advantageously serve to fix the WRFC to the substrate 11 for use in a braking environment, even if the coating is 1 mm thick or more.

### EXAMPLES

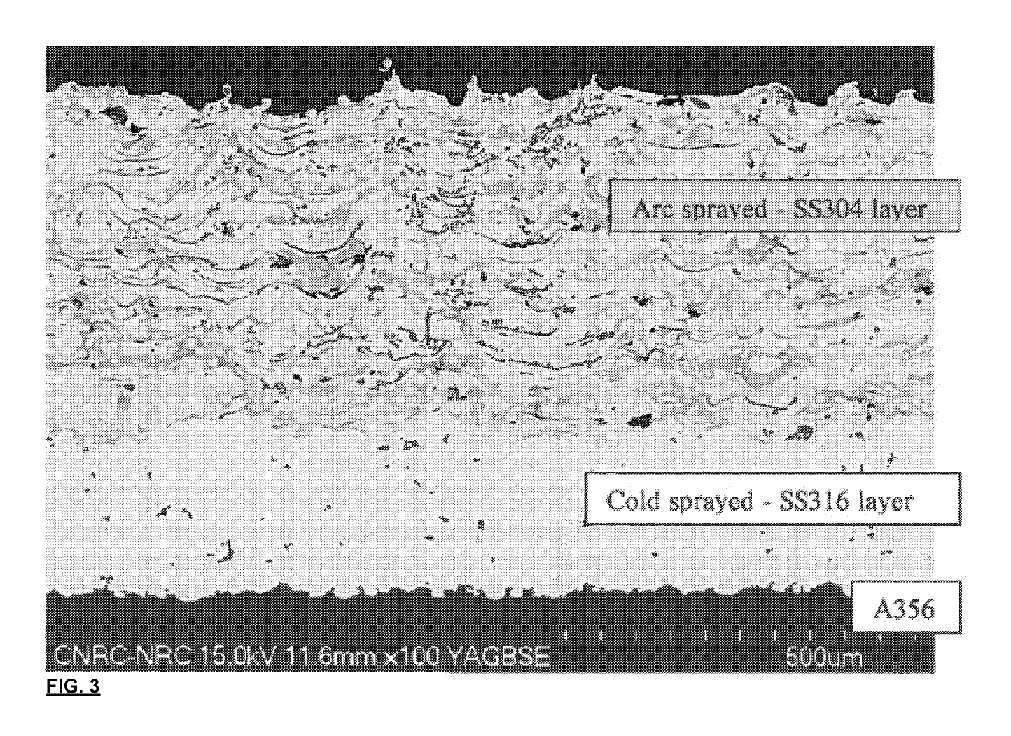

FIG. 3 shows a cross-section micrograph of a duplex (bond/WRFC) coating on an aluminum A356 substrate, in accordance with an example of the present invention. The A356 substrate appears dark and has an apparently rough meeting surface (where the A356 surface meets the cold-sprayed SS316 layer), which is evident by the piece-wise curved profile at the A356/SS316 interface cross-section. The interface is typical of a cold-sprayed or warm-sprayed coating. The energy of the particles colliding with the softer substrate allows for substantial deformation of the substrate, leading to a cratered interface. The bond coat is a cold gas dynamic sprayed coating composed of stainless steel SS316L. The cold gas dynamic sprayed bond coat displays good adhesion to the substrate, and, because of its low porosity, acts as a barrier to improve resistance to blister corrosion at the bond coat-substrate interface. The WRFC has been found to provide good wear properties. The micrograph shows a typical microstructure. A top layer appearing as a darkest area is produced by an epoxy used for dicing and polishing the cross-section, as is standard. Elongated porosity and wavelike deformations are visible in the WRFC, and regions of darker gray correspond with oxides.

Such coatings were produced according to the following process: machined A356 Al pucks were used for the trials. The cold gas dynamic spray bond coat was sprayed directly on the Al pucks (no surface roughness preparation was performed, and no cleaning was performed, as the pucks were recently machined) in two layers with a Kinetiks 4000 cold gas dynamic spray system obtained from CGT GMBH™, to reach a thickness of about 300 μm. The cold gas dynamic spray process used these spray parameters: powder=FE101 from Praxair™; powder feedrate=20 g/min; N₂ gas temperature=700° C.; N₂ gas pressure=40 bar; stand-off distance=8 cm; robot traverse speed of 300 mm/s; and step size of 2 mm. The WRFC coat, of about 500 μm thickness, was produced with a Sulzer Metco SmartArc™ following these spray parameters: wire=80T from Praxair, current=100A; air pressure=4.14 bar; stand-off=15.2 cm; robot traverse speed of 750 mm/s and step size of 6 mm.

The evaluation of different duplex coatings (varying coating stainless steel composition, thickness, and spraying parameters) has shown excellent thermal cycling resistance of the duplex coatings. FIG. 4 is a bar chart showing initial adhesion as well as thermal cycling resistance of a typical duplex coating. For reference, the bar chart shows bond strength and a number of cycles before spallation, of a cold gas dynamic sprayed coating and an arc sprayed coating, as well. Three samples were tested per coating type. The cold gas dynamic spray coating has an initial adhesion exceeding the adhesive strength (˜77 MPa) used for the pull test, which is represented by the arrow on the chart. Both the cold gas dynamic sprayed and duplex coatings withstood 5000 thermal cycles up to 550° C. without spalling, and thus their limit was not ascertained. The arc sprayed coating resisted 25% debonding for 600 cycles. The pull test used to ascertain the adhesive strength was performed in accordance with ASTM C633, and the thermal cycling test was performed with an in-house laser rig.

In this thermal cycling rig, coated samples are successively heated by a YAG laser and cooled down by air flow through the motion of a sample holder. Three samples are attached to the sample holder. Once the first sample is heated, it is moved to the cooling down region while the next sample is being heated. All process devices are thus stationary and enclosed in a chamber equipped with interlock doors and tinted windows for laser safe handling. Process monitoring and control is performed with Labview software (National Instrument, Austin, USA) from a computer outside the chamber. A specimen was first heated from the coated surface with a 2 kW CW YAG laser (Rofin Sinar, Hamburg, Germany) whose power was adjusted to 1300 W to obtain the desired heating rate of 50-55° C./s. After a heating time of 4s, the specimen was then quickly mechanically moved to the cooling zone where compressed air was directed to the coated surface. The 4s heating resulted in surface temperatures that never exceeded 500° C. Natural cooling occurred in the standby zone and as the sample holder location was reinitialized to start a new cycle.

The duplex coatings provided a sliding wear resistance equivalent to, or better than those usually obtained on cast iron, and substantially superior to bulk SS 304, or cold gas dynamic sprayed SS 316 coatings. The coefficient of friction is steady at about 0.45, which is typical of cast iron discs.

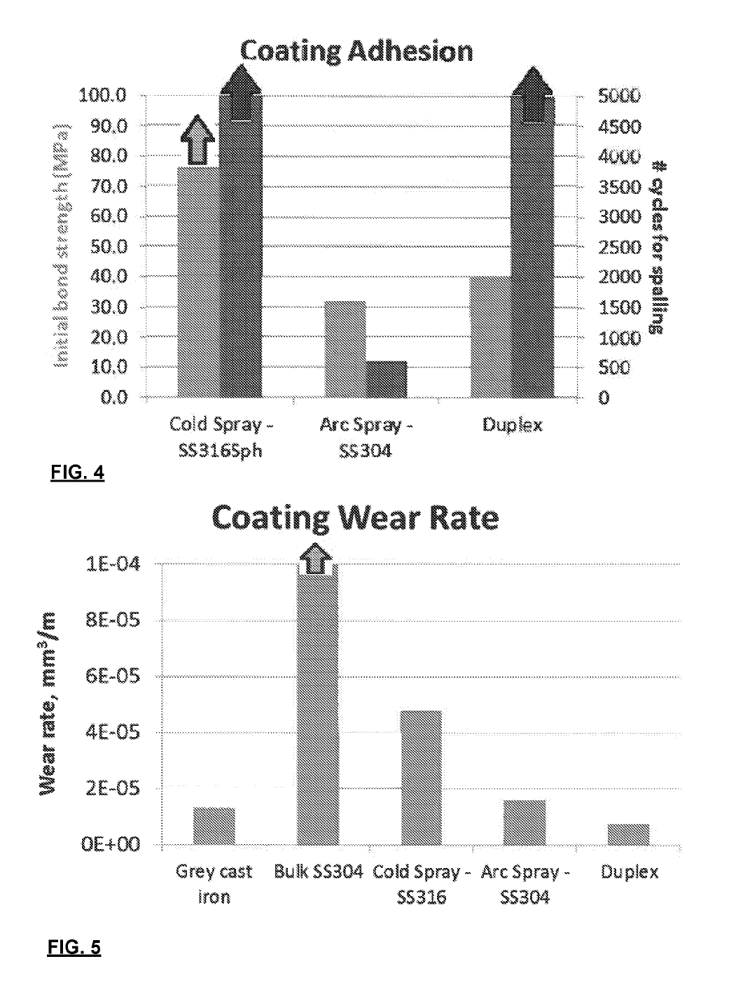

FIG. 5 is a bar chart showing wear rates of the duplex coating of FIG. 3 in comparison with a cold gas dynamic sprayed coating and an arc sprayed coating, as well as bulk stainless steel and grey cast iron. A Falex Multispecimen™ wear test rig was used to evaluate the wear performance of the developed coatings with a pin-on-disk contact configuration. Test pins were cut from a brake pad. The apparent contact area dimensions of the pins were 5 mm×5 mm with a length of about 13 mm. Cutting of the test pins was such that the wear surface was parallel with the original brake pad surface. Test disks had diameters of 86.36 mm and thicknesses of 10.16 mm. The following testing protocol was determined to be most appropriate, based on a series of preliminary tests on the effects of sliding speed (1 to 4 m/s), normal load (1 to 4 MPa), wear track diameter (38.1 to 63.5 mm), and total sliding distance (2,500 m to 200,000 m): speed=1 m/s; load (apparent contact pressure)=4 MPa; total sliding distance=48,000 m; and wear track diameter=63.5 mm.

Wear rate of the test disks was expressed in volume loss per sliding distance, mm³/m, and was obtained through weight loss measurement and estimated material density. The scale used for weight loss measurement is accurate to 0.01 mg.

Exposure of coatings to a cyclic corrosion test revealed that the duplex coating offers excellent corrosion resistance compared with (only) arc sprayed WRFCs. In order to simulate the effect of the most corrosive conditions encountered by brake disks, a laboratory cyclic corrosion test inspired by standard ISO 14993 was used to determine corrosion resistance. One cycle of the cyclic corrosion procedure employed was defined as follows: Step 1. Salt-spray with 5% NaCl at 34±3° C. (100% RH) (for 3 hours); Step 2. Drying at 59±6° C. and 27±7% RH (for 5 hours); Step 3. Wetting at 487° C. and >95% RH (for 4 hours).

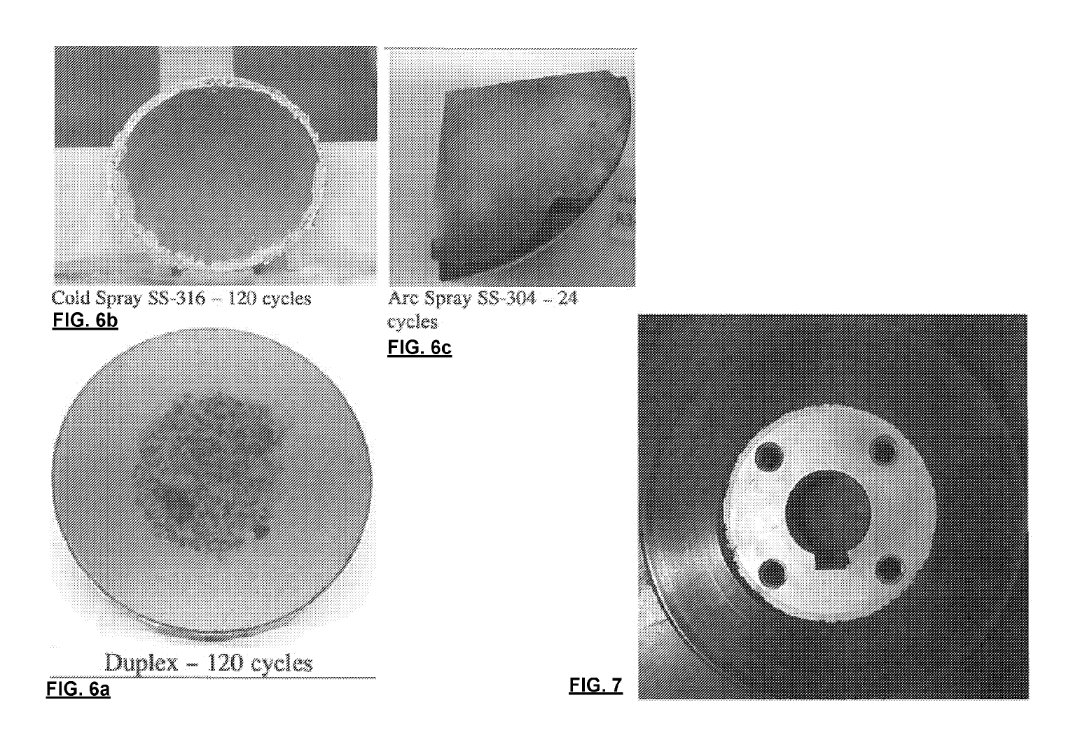

The arc sprayed WRFCs debonded after 24 cycles, with spalling initiated well before this, whereas the duplex coating withstood 120 cycles, the whole test duration. The duplex coating gave no indication of spalling or debonding after the cyclic corrosion test, and showed minimal traces of corrosion. FIG. 6a is a photograph of the duplex coating after 120 cycles. FIG. 6b is a photograph of the cold-sprayed SS 316 after 120 cycles. FIG. 6c is a photograph of a part of the arc-sprayed WRFC after failure at 24 cycles. It will be appreciated that a typical brake rotor for a car would have an annular surface.

Finally the duplex coating was subjected to a scale dynamometer to simulate actual braking conditions. The friction tests included a variety of stops with different characteristics (length, deceleration rate, etc.) to simulate various braking conditions as well as thermal shocks. The following data was taken at 50 Hz during each stop; internal aluminum temperature (via thermocouple mounted 0.5 mm below the coated surface of the disc); sample contact surface temperature (via an infrared sensor); force applied to the pads; the resultant torque on the pads; and the speed of the disc. The coatings were found to exhibit very stable wear characteristics with a steady constant coefficient of friction of about 0.35. Those results are consistent with the pin-on-disc laboratory wear testing. Using typical brake materials for the pins, pin-on-disc testing confirmed that, the coefficient of friction, measured at 0.42 in that case, varied by 10%, over 600 min (after initial running-in).

FIG. 7 shows the duplex coating after testing on a scale dynamometer. It can be seen that the coating is still sound and adhering to the substrate.

Other advantages and applications that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A mechanical part with a structural member composed of a lightweight metallic substrate bearing a wear surface for friction contact with a second part, the wear surface having the following structure:
a dense metallic bond coat with a microstructure consistent with formation by cold gas dynamic spray, bonded directly to the structural member; and
a wear resistant friction coating (WRFC) provided over the bond coat having a microstructure consistent with formation by thermal spray, the WRFC being bonded directly to the bond coat, or to an intermediate layer,
wherein the wear surface is composed of more iron (Fe) than any other element by mass, and has a thickness greater than 300 μm.

2. The mechanical part of claim 1 wherein the lightweight metallic substrate includes a metallic phase having 60 wt. % of one or more light structural metals like Al, or Mg, with optionally one or more of the following: Si, Cu, Li, Zn, Fe, Ni, Cr, Mn, Ti.

3. The mechanical part of claim 2 wherein the metallic phase is Al, or an alloy of Al.

4. The mechanical part of claim 2 wherein the lightweight metallic substrate is a metal matrix composite material, with the metallic phase being its metal matrix.

5. The mechanical part of claim 1 wherein the wear surface is composed of:
at least 40 wt. % Fe;
more steel by weight than any other feedstock material;
more steel by weight than any other feedstock material, the steel comprising Fe and C, and one or more of Ni, Cr, Mn, Al, Mo;
one or more cold gas dynamic spray layers and one or more thermal spray layers; or
one or more cold gas dynamic spray layers covered by one or more thermal spray layers.

6. A method for depositing a wear resistant friction coating (WRFC) on a lightweight metallic substrate, the method comprising:
exposing a prepared surface on the substrate;
applying a cold gas dynamic spray bond coat containing more iron than any other single element directly onto the prepared surface; and
thermal spraying the WRFC coating over the bond coat to a thickness of at least 300 μm above the substrate.

7. The method of claim 6 wherein thermal spraying comprises operating a thermal spray (TS) torch and a TS feedstock supply to feed coating material to a plume of the thermal spray torch, for at least partial melting, and acceleration of the material, toward the bond coat.

8. The method of claim 7 wherein:
the thermal spray torch is one of a wire-arc, plasma, HVOF, warm spray, and flame spray apparatus;
the plume is an arc, and the TS feedstock supply is a wire feed; or
the TS feedstock consists of at least 40 wt. % of iron

9. The method of claim 6 wherein applying the cold gas dynamic spray bond coat comprises operating one of a cold spray (CS), warm spray and an HVOF spray torch to accelerate a CS feedstock to provide the coating by high deformation collision of the CS feedstock substantially as a solid.

10. The method of claim 6 wherein the WRFC is applied directly on the bond coat.

11. The method of claim 6 further comprising applying one or more intermediate coats on the bond coat prior to thermal spraying the WRFC.

12. The method of claim 11 wherein:
each intermediate coat is applied by thermal spray, or cold gas dynamic spray;
every layer is produced by at least one cold gas dynamic spray coating followed by at least one thermal spray coating, the last at least one thermal spray coating being the WRFC; or
applying one or more intermediate coats comprises varying a thermal spray or cold gas dynamic spray parameter during the coating to produce an intermediate coat having a graded composition, microstructure, or density.

13. The method of claim 6 wherein applying the bond coat comprises varying a spray parameter during the coating to produce a bond coat having a graded composition, microstructure, or density.

14. The method of claim 6 wherein exposing a prepared surface on the substrate does not involve peening, blasting, etching, or abrading the surface.

15. A brake comprising a structural piece composed of an Al or Al alloy having a surface bearing bi-layer coating with an exposed a wear resistant friction coating (WRFC), wherein a dense metallic bond coat composed of more iron than any other element by mass underlies the WRFC, the bond coat having a microstructure consistent with formation by cold gas dynamic spray.

16. The mechanical part of claim 1 wherein the bond coat:
is composed of at least 40 wt. % Fe;
is graded, in that a composition, microstructure, or density varies as a function of distance from the part;
is at least 200 μm thick; or
is composed of a different steel than the WRFC.

17. The mechanical part of claim 1 wherein the WRFC:
is composed of at least 40 wt. % Fe;
has a microstructure consistent with formation by a wire-arc thermal spray torch;
is at least 100 μm thick;
is at least 250 μm thick;
is at least 500 μm thick;
is less than 5 mm thick;
the WRFC is bonded directly to the bond coat;
the WRFC is bonded to the bond coat with at least one intermediate coat provided between the bond coat and WRFC, and each intermediate coat has a microstructure consistent with application by a thermal spray torch, or by cold gas dynamic spray; or
the WRFC is bonded to the bond coat with at least one intermediate coat provided between the bond coat and WRFC, and the at least one intermediate coat is graded, in that a composition, microstructure, or density varies as a function of distance from the part.

18. The brake of claim 15 wherein the bi-layer coating is composed of:
at least 40 wt. % Fe;
more steel by weight than any other feedstock material, the steel comprising Fe and C, and one or more of Ni, Cr, Mn, Al, Mo;
one or more cold gas dynamic spray layers and one or more thermal spray layers; or
one or more cold gas dynamic spray layers covered by one or more thermal spray layers.

19. The brake of claim 15 wherein the bond coat:
is composed of at least 40 wt. % Fe;
is graded, in that a composition, microstructure, or density varies as a function of distance from the part;
is at least 200 μm thick; or
is composed of a different steel than the WRFC.

20. The brake of claim 15 wherein the WRFC:
is composed of at least 40 wt. % Fe;
has a microstructure consistent with formation by a wire-arc thermal spray torch;
is at least 100 μm thick;
is at least 250 μm thick;
is at least 500 μm thick;
is less than 5 mm thick;
is bonded directly to the bond coat;
is bonded to the bond coat with at least one intermediate coat provided between the bond coat and WRFC, and each intermediate coat has a microstructure consistent with application by a thermal spray torch, or by cold gas dynamic spray; or
is bonded to the bond coat with at least one intermediate coat provided between the bond coat and WRFC, and the at least one intermediate coat is graded, in that a composition, microstructure, or density varies as a function of distance from the part.
